(19) United States
(12) Patent Application Publication
(10) Pub. No.: US 2007/0169796 A1
(43) Pub. Date: Jul. 26, 2007

(54) VEHICLE UNDERCARRIAGE WASHING APPARATUS

(76) Inventors: Dennis W. Johnson, Enterprise, AL (US); Jason Todd Bradshaw, Calera, AL (US); Cecil Bradshaw JR., Enterprise, AL (US); Charles E. Hercus, Kinston, AL (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/621,866

(22) Filed: Jan. 10, 2007

Related U.S. Application Data
(60) Provisional application No. 60/871,603, filed on Dec. 22, 2006.
(60) Provisional application No. 60/758,003, filed on Jan. 10, 2006.

(51) Int. Cl. B08B 3/04; B08B 3/12; B08B 3/00

(52) U.S. Cl. 134/123; 134/198; 134/172

(57) ABSTRACT

A mobile undercarriage cleaner design for (but not limited to) use on tractor trailers, buses, dump trucks and other such medium to heavy duty trucks and equipment is disclosed. The apparatus provides a frame to which is attached rotary flow lines that track circles of differing diameters. In one embodiment, one of the rotary flow lines is an upper rotary flow line that carries opposed cleaning nozzles, a lower flow line being a rotary flow line that rotates the first rotating flow line in a circular path. In another embodiment, rotating flow lines have nozzles at differing distances from a center of rotation by providing flow lines of differing lengths. The apparatus is intended for heavy duty, high pressure high temperature environments such as for use by commercial transportation fleets that require the removal of grease, oil, fuel, dirt, mud, salt or other like contaminants.

### CROSS-REFERENCE TO RELATED APPLICATIONS

Priority of U.S. Provisional Patent Application Ser. No. 60/871,603, filed 22 Dec. 2006 and of U.S. Provisional Patent Application Ser. No. 60/758,003, filed 10 Jan. 2006, both incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to an apparatus for the washing of an undercarriage of a commercial use vehicle such as a truck. More particularly, the present invention relates to an improved apparatus for washing the undercarriage of a truck or other like commercial use vehicle wherein a frame has rotating flow line arms, each equipped with a cleaning nozzle at an arm free end. Some arms are longer and some shorter so that the nozzles track different diameter concentric circles in one embodiment. In another embodiment, an upper rotating arm is mounted to an end portion of a lower rotating arm. A handle can be provided for placing the device under or removing the device from beneath a vehicle to be cleaned.

2. General Background of the Invention

Certain commercial vehicles are subjected to duty that dirties them with oil, fuel, dirt, mud, salt and other contaminates. Vehicles of this type can include for example tractor trailers, buses, dump trucks and other medium to heavy duty trucks and equipment.

The following possibly relevant patent documents are incorporated herein by reference. The following order of listing these references has no significance. U.S. Pat. Nos.: 4,580,726; 4,984,746; Des. 321,574; U.S. Pat. Nos. 5,707,014; 5,908,163; 5,653,392; Des. 394,921; U.S. Pat. Nos. 5,820,037; 6,131,831; 6,247,658; 2005/0205116.

U.S. Pat. Nos. 6,247,658, 5,707,014, 4,984,746 and 2005/0205116 relate to portable undercarriage cleaners for vehicles.

U.S. Pat. Nos. 5,908,163, 5,653,392, Des. 394,921 and Des. 321,574 relate to portable undercarriage washers for vehicles that are connected to a hose and that can be rolled under vehicles.

U.S. Pat. Nos. 4,580,726, 6,131,831 and 5,820,037 relate to undercarriage washers that have a reservoir for holding detergent that is sprayed under the vehicle to clean it.

### BRIEF SUMMARY OF THE INVENTION

The present invention provides a mobile undercarriage cleaner apparatus that is designed for (but not limited to) use on commercial grade vehicles. The apparatus of the present invention is specially configured to remove grease, oil, fuel, dirt, mud, salt and other contaminates from vehicles such as medium to heavy duty trucks and like equipment. Multiple embodiments are disclosed.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective view of the preferred embodiment of the apparatus of the present invention;

FIG. 2 is a top view of the preferred embodiment of the apparatus of the present invention;

FIG. 3 is a side view of the preferred embodiment of the apparatus of the present invention;

FIG. 4 is a fragmentary view of the preferred embodiment of the apparatus of the present invention;

FIG. 5 is a partial elevation view of the preferred embodiment of the apparatus of the present invention;

FIG. 6 is a plan view of an alternate embodiment of the apparatus of the present invention;

FIG. 7 is a side view of the alternate embodiment of the apparatus of the present invention;

FIG. 8 is a fragmentary side view of the alternate embodiment of the apparatus of the present invention; and

FIG. 9 is a partial plan view of the alternate embodiment of the apparatus of the present invention.

### DETAILED DESCRIPTION OF THE INVENTION

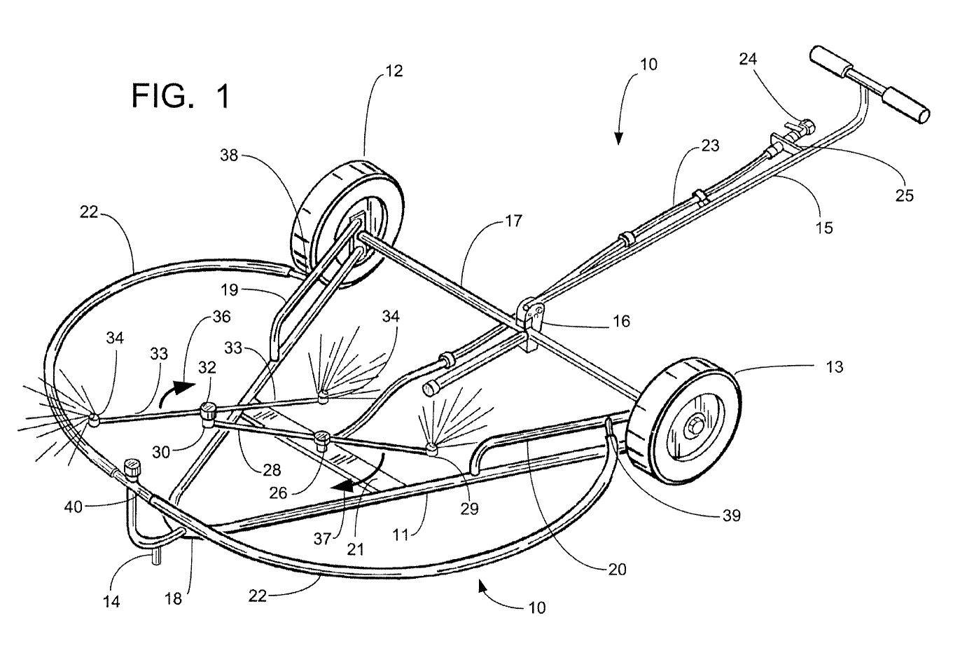

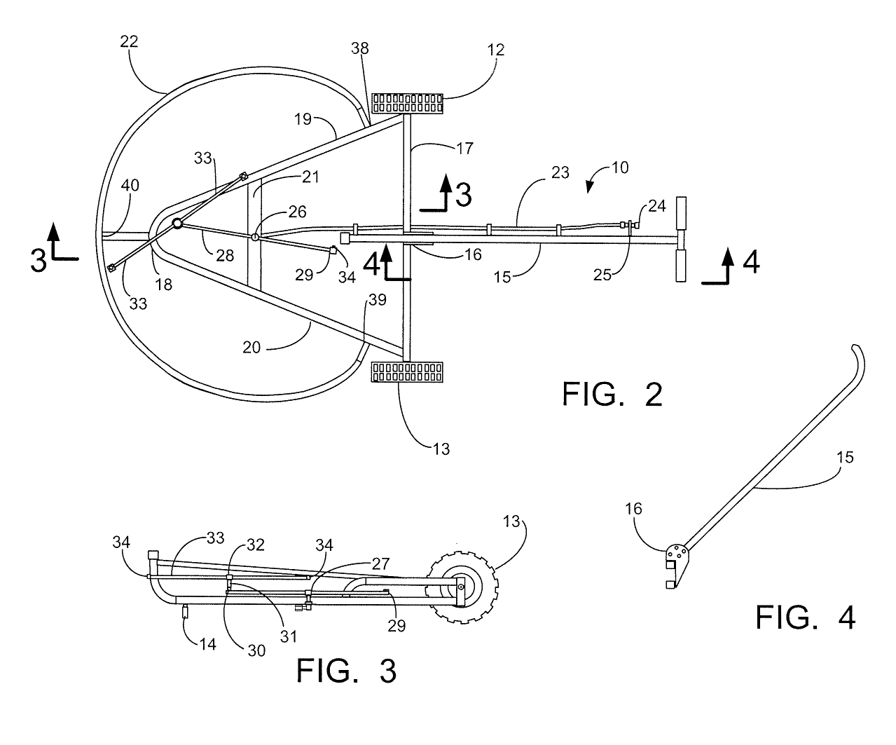

Vehicle undercarriage washer 10 is shown in FIGS. 1-3. The apparatus 10 includes a frame 11 (e.g. welded steel or aluminum) that includes a generally triangularly shaped section as shown in FIG. 4. The frame 11 is preferably wheeled, providing a pair of rear wheels 12, 13 that can be fixed with respect to frame 11, and a foot 14 that is not steerable. A single foot 14 can alternatively be a rotating caster or other steerable wheel.

Handle 15 attaches to the rear 17 of frame 11 using for example a pivotal connection 16. By optionally placing the foot 14 or a caster or other steerable wheel at the front 18 portion of frame 11 and opposite rear wheels 12, 13 and handle 15, the apparatus 10 of the present invention can easily be moved under or withdrawn from a position under a vehicle to be cleaned.

The frame 11 also includes sides 19, 20 that extend forwardly from rear 17 and that meet at front section 18. Thus, each of the vertices of the triangular shape of frame 11 carries a wheel 12, 13, or a foot 14 (or optionally a wheel).

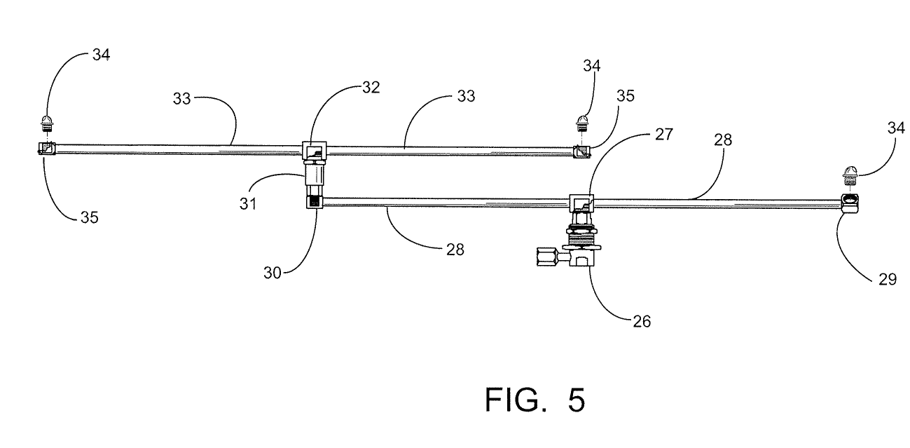

A transverse beam 21 is provided on frame 11, positioned about midway in between front section 18 and rear section 17 as shown in FIG. 4. The transverse beam 21 supports a lower rotating flow line 28. The lower rotating flow line 28 can be attached to beam 21 using a lower rotary connection 26 and tee fitting 27 as shown in FIG. 5.

Lower rotary flow line 28 carries elbow fitting 29 at one end portion and an elbow fitting 30 at the other end portion. The elbow 30 has an upper rotary connection 31 and a tee fitting 32 for supporting an upper rotary flow line 33. Nozzles 34 are provided at end portions of flow line 33, each nozzle 34 being attached to the flow line 33 with an elbow fitting 35. Similarly, a nozzle 34 can be attached to elbow fitting 29 as shown in FIG. 5.

During use, a hose or other flow line 23 carries cleaning fluid such as water or a mixture of water and a cleaning agent to the rotary flow lines 28, 33. Hose 23 provides an influent fitting 24. Hose 23 can be provided with a valve 25 downstream of the influent fitting 24. When the valve 25 is opened, pressurized fluid (for example, supplied with a pressure washer or like device or system) flows through inlet fitting 24 and valve 25 to rotary connection 26. Rotary connection 26 provides an inlet fitting 38 to which flow line 23 can attach using a threaded or clamped connection, for example. Water is thus supplied via the rotary connection 26 to the first rotating flow line 28. Water or a water/cleaning fluid mix then travels to elbow fitting 29 and nozzle 34 and via elbow fitting 30 to second rotary connection 31 and tee fitting 32. The tee fitting 32 then conveys pressurized fluid via rotating flow line 33 to elbow fittings 35 and nozzles 34.

The nozzles 34 are angled so that they rotate the rotary flow line 28 in the direction of arrow 37 and the flow line 33 in the direction of arrow 36 in FIG. 1. Thus, the nozzles 34 can be angled about twenty degrees with respect to a plane defined by the rotation of second rotary flow line 33. Arrows 37 in FIG. 1 illustrate a rotation of the rotary flow line 28. The rotary flow line 28 rotates so that rotary connection 31 also rotates in a circular path about the first rotary connection 26.

A peripheral guard 22 can be provided that extends in a generally circular path, being attached to frame 11 at attachments 38, 39, 40.

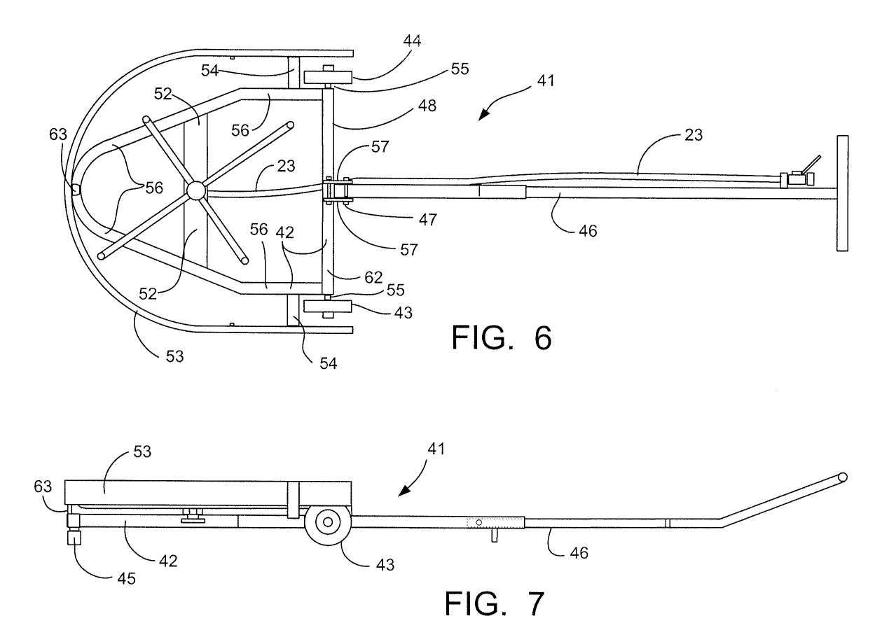

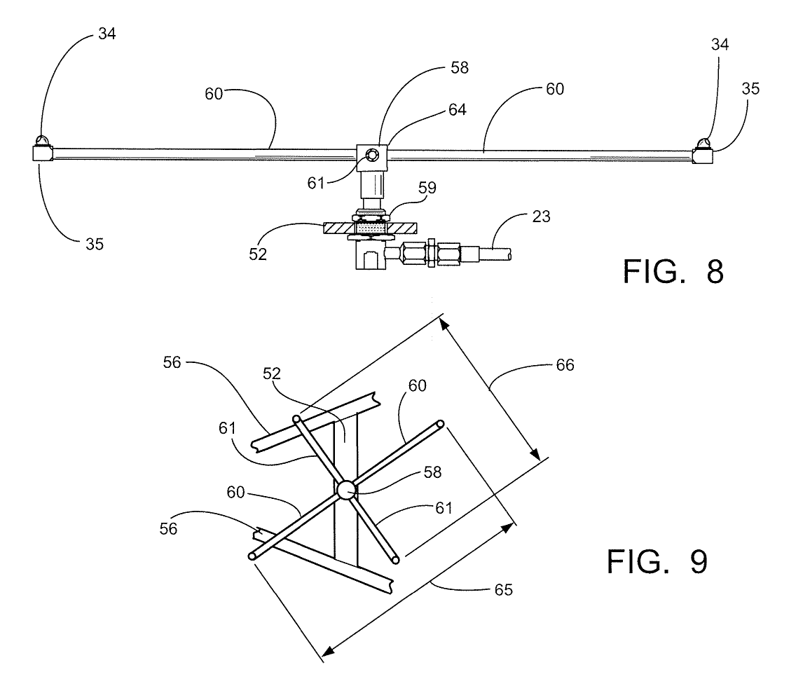

FIGS. 6-9 show an alternate embodiment of the apparatus of the present invention, designated by the numeral 41 in FIGS. 6-7. Vehicle undercarriage washer 41 provides a frame 42 (e.g. welded steel or welded aluminum) having a rear section 48 that can be fitted with wheels 43, 44. A forward foot or caster 45 can be affixed to a front section 49 of frame 42. The frame 42 can be generally triangularly shaped with wheels 43, 44, foot 45 attached to frame 42 at vertices of the generally triangular shape as shown in FIGS. 6-7.

A handle 46 can be attached to frame 42 using a pivotal connection 47 for example. Frame 42 can include generally triangular section 56 and rear transverse member or beam 62 and central transverse member or beam 52. Rear transverse member or beam 62 can be fitted with axles 55 as shown. Each axle 55 can support a wheel 43 or 44.

A peripheral guard 53 extends around the rotating flow line assembly 58 as shown in FIGS. 6-7. Guard 53 can be attached to frame 42 using a plurality of guard supports 54, 63. The guard supports can include a pair of lateral guard supports 54 and one or more forward guard supports 63. One or more brackets 57 can form a pivotal connection between handle 46 and frame 42 rear transverse beam or member 62. Handle 46 can be bolted to bracket(s) 57. Brackets 57 can be attached to rear transverse beam or member 62 using welding for example.

Rotating flow line assembly 58 can be attached to frame 42 at central transverse beam member 52 using a rotary flow conveying swivel 59 that enables fluid to be pumped to hub 64 and the rotating flow line arms 60, 61 and nozzles 34. Such rotating fluid conveying swivels 59 are commercially available.

Rotating assembly 58 include multiple nozzles positioned on the rotating assembly 58 wherein at least some of the nozzles 34 track circles of differing diameters. Flow line arms 60, 61 are provided that are of different lengths (see arrows 65, 66 in FIG. 9). Flow line arms 60 are longer than flow line arms 61 (see FIGS. 6 and 8-9 ). Each flow line arm 60, 61 can be provided with an elbow fitting 35 and a nozzle 36 as shown in the preferred embodiment (see FIG. 5). The nozzles 36 mounted at the free end of arms 60 will track a larger diameter circle. The nozzles 36 mounted at the free end of arms 61 will track a smaller diameter circle.

The washers of the present invention can operate at typical pressures of 1000-4000 psi (70.31 kgf/cm²-281.2 kgf/cm²) (input pressure from a pressure washer—this usually results in a pressure at the nozzles of around 250 psi-2200 psi (17.58 kgf/cm²-154.7 kgf/cm²)), though usually the input operating pressure will be around 1200-3000 psi (84.37 kgf/cm²-210.9 kgf/cm²). The nozzles used in these washers can withstand such pressures without damage to the nozzles. The washers of the present invention can operate at typical temperatures of up to 250 degrees F. (121 degrees C.).

In the embodiment of the invention shown in FIGS. 1-5, preferably a #2502 nozzle (#2 size hole with a 25 degree angle of spray) is used on the lower arm 28 and a #003 nozzle (#3 size hole, 0 degree angle of spray) is used for each of the two upper nozzles 34. The pitch on all three nozzles is preferably around 11 degrees (believed to be optimal for rotating of the nozzle assemblies). These nozzles 34 are preferably ¼″ (0.635 cm) nozzles with a stainless steel housing with ceramic insert made by St. Gobain of Italy.

The swivels 26, 31 are preferably all stainless steel, sealed, and self-lubricating (and can be purchased from MOSMATIC Corporation, BRISTOL, Wis. 53104-0400 USA, www.mosmatic.com—www.mosmatic.com is incorporated herein by reference). The rotating assemblies 58 are preferably made of stainless steel and made by MOSMATIC. The handle and frame of the unit can be made of powder coated carbon steel, for example, and the guard 22, 53 is preferably made of plastic (such as ½″ (1.27 cm) tubing made of ABS plastic).

In the embodiment of the invention shown in FIGS. 6-9, preferably two #2502 full stainless steel ⅛″ (0.318 cm) nozzles 34 are used on the long arms 60, and are pitched at around 11 degrees and two #4002 (#2 size hole with a 40 degree angle of spray) full stainless steel ⅛″ (0.318 cm) nozzles (vertical—no pitch) are used on the short arms 61. The swivels and nozzles can be manufactured by Mosmatic.

The swivel 59 is preferably all stainless steel, sealed, and self-lubricating (and can be purchased from MOSMATIC Corporation, BRISTOL, Wis. 53104-0400 USA, www.mosmatic.com—www.mosmatic.com is incorporated herein by reference). The rotating assemblies (e.g. 58) are preferably made of stainless steel and made by MOSMATIC. The handle 46 and frame 42 of the unit 41 can be made of powder coated carbon steel, for example, and the guard 53 is preferably made of plastic (such as UHMW plastic ¼″ (0.635 cm) by 2 inch (5.08 cm) wide stripping).

The present invention as shown in FIGS. 1-5 is commercially available at www.nolimitindustries.com and is sold under the trademark Bottom Feeder™. The present invention as shown in FIGS. 6-9 will soon be commercially available at www.nolimitindustries.com and will be sold under the trademark Mud Cat™. The commercial embodiments shown at www.nolimitindustries.com as of the date of filing of this patent application are incorporated herein by reference. Also incorporated herein by reference are the videos on that website which show operation of these washers.

The following is a list of parts and materials suitable for use in the present invention.

PARTS LIST

| Part | |
|---|---|
| Number | Description |
| 10 | vehicle undercarriage washer |
| 11 | frame |
| 12 | wheel |
| 13 | wheel |
| 14 | foot or caster |
| 15 | handle |
| 16 | pivotal connection |
| 17 | rear section |
| 18 | front section |
| 19 | side |
| 20 | side |
| 21 | transverse beam/member |
| 22 | peripheral guard |
| 23 | hose |
| 24 | influent fitting |
| 25 | valve |
| 26 | lower fluid conveying swivel/rotary connection |
| 27 | tee fitting |
| 28 | lower rotating flow line |
| 29 | elbow fitting |
| 30 | elbow fitting |
| 31 | upper fluid conveying swivel/rotary connection |
| 32 | tee fitting |
| 33 | rotating flow line |
| 34 | nozzle |
| 35 | elbow fitting |
| 36 | arrow |
| 37 | arrow |
| 38 | attachment |
| 39 | attachment |
| 40 | attachment |
| 41 | vehicle undercarriage washer |
| 42 | frame |
| 43 | wheel |
| 44 | wheel |
| 45 | foot or caster |
| 46 | handle |
| 47 | pivotal connection |
| 48 | rear section |
| 49 | front section |
| 50 | side |
| 51 | side |
| 52 | central transverse beam/member |
| 53 | peripheral guard |
| 54 | lateral guard support |
| 55 | axle |
| 56 | triangular section |
| 57 | bracket |
| 58 | rotating flow line assembly |
| 59 | rotating fluid conveying swivel |
| 60 | arm |
| 61 | arm |
| 62 | rear transverse beam/member |
| 63 | forward guard support |
| 64 | hub |
| 65 | dimension arrow |
| 66 | dimension arrow |

All measurements disclosed herein are at standard temperature and pressure, at sea level on Earth, unless indicated otherwise.

The foregoing embodiments are presented by way of example only; the scope of the present invention is to be limited only by the following claims.

1. A vehicle undercarriage washing apparatus, comprising:
a) a wheeled frame;
b) a handle that attaches to the frame, the handle enabling a user to push the frame under a vehicle to be cleaned and to withdraw the frame when vehicle undercarriage cleaning is completed;
c) a first, lower rotating flow line that rotatably mounts to the frame, the first lower flow line having first and second end portions with a first rotary connection in between the first and second ends and a second rotary connection next to one of the end portions;
d) a second, upper rotating flow line that attaches to the first flow line at the second rotary connection, the second, upper flow line having opposed ends;
e) cleaning nozzles mounted at the ends of the second rotating flow line;
f) a manifold that transmits cleaning fluid between the handle and the first, lower rotary flow line, the manifold having an inlet fitting, there being fluid communication between the inlet fitting and the nozzles; and
g) the first and second rotating flow lines and nozzles being so configured that when fluid is transmitted via the manifold to the nozzles, both the first and second rotating flow lines rotate.

2. The vehicle undercarriage washing apparatus of claim 1 wherein the handle is pivotally attached to the frame.

3. The vehicle undercarriage washing apparatus of claim 1 wherein the frame is generally triangular in shape.

4. The vehicle undercarriage washing apparatus of claim 1 further comprising a guard that extends peripherally around the first and second rotating flow lines.

5. The vehicle undercarriage washing apparatus of claim 3 wherein at least two of the vertices of the triangularly shaped frame have wheels attached thereto.

6. The vehicle undercarriage washing apparatus of claim 1 wherein one of the rotating flow lines is attached to the frame with a fluid conveying swivel.

7. The vehicle undercarriage washing apparatus of claim 1 wherein the first, lower rotating flow line attaches to the second, upper rotating flow line with a fluid conveying swivel.

8. The vehicle undercarriage washing apparatus of claim 1 wherein at least one nozzle attaches to the second, upper rotating flow line with a connection that enables the nozzle to be angled a selected number of degrees relative to a plane defined by rotation of the second, upper rotating flow line.

9. The vehicle undercarriage washing apparatus of claim 8 wherein the selected angle is about 20 degrees.

10. The vehicle undercarriage washing apparatus of claim 1 wherein one of the wheels attached to the frame is a steerable wheel.

11. The vehicle undercarriage washing apparatus of claim 1 wherein there are three wheels attached to the frame, at least one being steerable.

12. The vehicle undercarriage washing apparatus of claim 11 wherein the steerable wheel is positioned on the frame opposite the handle.

13. The vehicle undercarriage washing apparatus of claim 1 wherein one of the wheels is a lockable caster wheel.

14. A vehicle undercarriage washing apparatus, comprising:
a) a movable, transportable frame;
b) a handle that attaches to the frame, the handle enabling a user to push the frame under a vehicle to be cleaned and to withdraw the frame when vehicle undercarriage cleaning is completed;
c) multiple rotating flow line arms that rotatably mount to the frame with a fluid conveying swivel, each rotating flow line arm having first and second end portions, the first end portion connected to the fluid conveying swivel and extending radially therefrom;
d) a cleaning nozzle mounted at the second end of each rotating flow line arm, some of the rotating arms being larger than others;
e) a non-rotating water conveying flow line that transmits water between an inlet fitting and the fluid conveying swivel, there being fluid communication between the inlet fitting and the nozzles; and
f) the nozzles being positioned at the ends of the rotating flow line arms to track concentric circles of differing diameters.

15. The vehicle undercarriage washing apparatus of claim 14 wherein the frame includes a generally triangularly shaped section.

16. The vehicle undercarriage washing apparatus of claim 14 wherein the rotating flow line arms include a first pair of flow line arms, each with a nozzle positioned a first distance from the fluid conveying swivel and a second pair of flow line arms, each with a nozzle positioned a second distance from the fluid conveying swivel, the first distance being greater than the second distance.

17. The vehicle undercarriage washing apparatus of claim 14 further comprising a guard that extends peripherally around the rotating flow line arms.

18. The vehicle undercarriage washing apparatus of claim 15 wherein at least two vertices of the generally triangularly shaped frame have wheels attached thereto.

19. The vehicle undercarriage washing apparatus of claim 14 wherein the rotating flow line arms extend radially from the fluid conveying swivel and are spaced circumferentially equal distances.

20. The vehicle undercarriage washing apparatus of claim 19 wherein there are more than two nozzles.

21. The vehicle undercarriage washing apparatus of claim 20 wherein there are four rotating nozzles.

22. The vehicle undercarriage washing apparatus of claim 21 wherein the frame includes a peripheral member and a transverse member mounted to the peripheral member at end portions of the transverse member and wherein the fluid conveying swivel is mounted on the transverse member.

23. A vehicle undercarriage washing apparatus, comprising:
a) a frame;
b) a first, lower rotating flow line that rotatably mounts to the frame, the first, lower flow line having first and second end portions with a first rotary connection in between the first and second ends and a second rotary connection next to one of the end portions;
c) a second, upper rotating flow line that attaches to the first flow line at the second rotary connection, the second, upper flow line having opposed ends;
d) multiple cleaning nozzles mounted at the ends of the rotating flow lines;
e) a manifold that transmits cleaning fluid between the handle and the first, lower rotary flow line, the manifold having an inlet fitting, there being fluid communication between the inlet fitting and the nozzles; and
f) the first and second rotating flow lines and nozzles being so configured that when fluid is transmitted via the manifold to the nozzles, both the first and second rotating flow lines rotate.

24. The vehicle undercarriage washing apparatus of claim 23 wherein the handle is pivotally attached to the frame.

25. The vehicle undercarriage washing apparatus of claim 23 wherein the frame is generally triangular in shape.

26. The vehicle undercarriage washing apparatus of claim 23 further comprising a guard that extends peripherally around the first and second rotating flow lines.

27. The vehicle undercarriage washing apparatus of claim 25 wherein at least two of the vertices of the triangularly shaped frame have wheels attached thereto.

28. The vehicle undercarriage washing apparatus of claim 23 wherein one of the rotating flow lines is attached to the frame with a fluid conveying swivel.

29. The vehicle undercarriage washing apparatus of claim 23 wherein the first, lower rotating flow line attaches to the second, upper rotating flow line with a fluid conveying swivel.

30. The vehicle undercarriage washing apparatus of claim 23 wherein at least one nozzle attaches to the second, upper rotating flow line with a connection that enables the nozzle to be angled a selected number of degrees relative to a plane defined by rotation of the second, upper rotating flow line.

31. The vehicle undercarriage washing apparatus of claim 30 wherein the selected angle is about 20 degrees.

32. The vehicle undercarriage washing apparatus of claim 23 wherein one of the wheels attached to the frame is a steerable wheel.

33. The vehicle undercarriage washing apparatus of claim 23 wherein there are three wheels attached to the frame, at least one being steerable.

34. The vehicle undercarriage washing apparatus of claim 23 wherein the steerable wheel is positioned on the frame opposite the handle.

35. The vehicle undercarriage washing apparatus of claim 23 wherein one of the wheels is a lockable caster wheel.

36. The invention(s) substantially as shown and/or described herein.
